(19) United States
(12) Patent Application Publication
(10) Pub. No.: US 2013/0143536 A1
(43) Pub. Date: Jun. 6, 2013

(54) REAL-TIME PARKING AVAILABILITY SYSTEM

(71) Applicant: Massachusetts Institute of Technology, Cambridge, MA (US)

(72) Inventor: Carlo Filippo Ratti, Cambridge, MA (US)

(73) Assignee: Massachusetts Institute of Technology, Cambridge, MA (US)

(21) Appl. No.: 13/705,857

(22) Filed: Dec. 5, 2012

Related U.S. Application Data
(60) Provisional application No. 61/567,291, filed on Dec. 6, 2011.

(51) Int. Cl. H04W 4/00

(52) U.S. Cl. CPC H04W 4/003
USPC 455/414.1

(57) ABSTRACT

Real-time parking availability system. The system includes a database including an inventory of parking spaces in a city including their location, size, and level of demand. A mobile phone is programmed for access to the database to locate a vacant space, to pay for a requested time duration in the space, and to update the database to remove the space from the database of available parking spots for the requested time duration. The parking spaces may accommodate an automobile or a plurality of bicycles.

This application claims priority to U.S. provisional patent application Ser. No. 61/567,291 filed on Dec. 6, 2011, the contents of which are incorporated herein by reference.

### BACKGROUND OF THE INVENTION

This invention relates to a real-time parking availability system and, more particularly, to a system that uses drivers to collect and transmit parking spot availability information.

Drivers have long complained about the endless search for parking—but what is seldom realized is how much this inconvenience extends beyond the limits of their car. Drivers circling endlessly to find a vacant spot turn be linked to many prominent problems in cities such as by affecting the quality of urban life by contributing to traffic congestion, pollution, increasing driving hazards (both for other drivers and for pedestrians), and a reduction of public space, A number of studies have recently attempted to quantify these inconveniences. According to the Texas Transportation Institute's 2007 Urban Mobility Report, in 2005 alone traffic congestion in 437 urban areas across the US cost an estimated $78.2 billion. This cost is measured by the travel time index which is the ratio of travel time in rush-hour to travel time during quiet periods and has increased from 1.09 in 1982 to 1.26 in 2005¹. Moreover, according to a report on transportation provided by the University of Minnesota for Maplewood, Minn., the city's drivers used 97,043 gallons of gasoline and diesel fuel in 2007, a 10.15% increase from 2006².

Over the past few years, a number of “smart parking systems” have been introduced in cities all over the world in order to reduce the parking problem and improve livability of urban areas, Portland, Oreg., one of the smart-meter pioneers, saw an increase of more than $2 million in parking revenue between 2002 and 2005 after replacing its more than 7,000 parking meters with 1,130 multi-space meters according to DKS Associates, a transportation planning and engineering firm³.

The city of New York, in 2009, started the “park-smart”⁴ program in Greenwich Village, Parking meter rates go up from $1.00 per hour to $2.00 per hour during the busiest part of the day in an effort to increase parking turnover.⁵

The city of Los Angeles, Department of Transportation has introduced a new parking meter system known as “Park and Pay,” The multi-space pay station options include coin, credit card, and cell phone as well as paper currency payment and monthly parking pass sales in certain off-street lots⁶.

The city of San Francisco has installed a parking system made by several underground sensors (one for each parking plot) that tell whether a vehicle is parked in a space. Meters in 6,000 of the city's 24,000 parking spaces will then make it possible for motorists to find parking spaces online from their cell phones. The system uses a wireless sensor embedded in a 4-inch-by-4-inch piece of plastic, fastened to the pavement adjacent to each parking space⁸.

Washington D.C. has installed multi-space smart meters that take credit cards or coins in six neighborhoods and has plans to install additional ones⁹.

Denver, which already has a “cash key” prepaid meter system in which motorists insert a key-like device into a meter to pay for parking time, is trying out solar-powered meters that take credit and debit cards as well as coins¹¹.

Each of these systems, however, requires the deployment of a new and most often quite expensive infrastructure. It is an object of the present invention to provide a parking system that is completely independent of physical parking meters but rather is empowered by a real-time data networking in “the cloud.”

The present invention utilizes mobile phones, such as smart phones, and the penetration of such phones in the developing world is expected to reach nearly 45%, presenting a powerful platform for sensing and information dissemination at a resolution never before seen.

### SUMMARY OF THE INVENTION

The real-time parking availability system according to the invention includes a database having an inventory of parking spaces in a region such as a city including their location, size, and level of demand. A mobile phone is programmed for access lo the database to locate a vacant space, to pay for a requested time duration in the space, and to update the database to remove the space from the database of available parking spots for the requested time duration. In a preferred embodiment, the mobile phone includes an augmented reality application to identify whether a parked car has paid for the space and to identify how much time remains. The inventory of parking spaces may accommodate an automobile or a plurality of smaller vehicles such as bicycles.

In another embodiment, the mobile phone is further programmed to extend the requested time duration for a particular parking spot. In these embodiments, it is preferred that the database he stored in the digital cloud. It is also contemplated that the cost of the requested time duration will vary based on demand.

The system disclosed herein, referred to as Park-Pass, incorporates an inventory of ail existing parking spaces in a given jurisdiction such as a city including their location, size, and level of demand. The present system allows individual users to navigate through an urban environment to efficiently find parking using an augmented reality application on a mobile phone. Once a space has been identified, individuals can electronically validate their parking through an online payment system. The payment, in turn, feeds back information to the system, removing the parking spot that has just been occupied from the database of available parking spots for the time duration requested by the driver. The system of the invention frees cities from physical installations of smart, meters or sensors to identify available parking spots, instead using drivers to collect and transmit this information.

The present invention uses a mobile phone which may be a smart phone or a traditional cell phone.

The system of the invention is highly adaptive in that it is able to allocate a parking space for both cars and bicycles, responding to the demands placed on the system by its users. One parking space may be used either by a single car or up to 10 bicycles. The invention thus not only encourages the use of bicycles but also formally deals with the occasional need to provide sufficient parking spaces for cyclists within cities. The system of the invention also focuses on altering individuals' behavior and developing parking enforcement to system users through civic engagement. If a driver arrives at a parking spot that was supposed to be vacated by another driver, but has remained occupied, the driver has the option of reporting the violator using the mobile phone's augmented reality system.

In a city where parking is at a premium, the introduction of an infrastructure-less parking system has the potential to reduce congestion on the roads and also to help to improve air quality. With an intelligent system feeding back information in real time as to the location of available parking spaces, time spent searching for parking can be greatly reduced. The system of the invention can also be integrated into vehicle navigation systems that could further streamline the parking process.

By optimizing existing parking facilities through an inexpensive, scalable, and infrastructure-less system, the Park-Pass system of the invention offers a digitally-enabled alternative to the challenges of parking in urban areas. The system of the invention aims to reduce traffic congestion caused by drivers searching for parking spaces and allows drivers to navigate more efficiently through the road network within cities. As users contribute to the database of the system, providing information not only about space availability but also about people breaching the system, the system of the invention promotes a level of civic engagement within the urban context.

### BRIEF DESCRIPTION OF THE DRAWING

FIG. 1(a) is a pictorial representation showing parking spaces in a jurisdiction.

FIG. 1(b) represents a cell tower for the telephone network and Internet that may be used in the invention.

FIG. 1(c) is a schematic representation of a computer server in the so-called “cloud,”

FIG. 1(d) is another view of parking spots.

FIG. 1(e) is an illustration of a smart phone screen implementing the present invention.

### DESCRIPTION OF PREFERRED EMBODIMENT

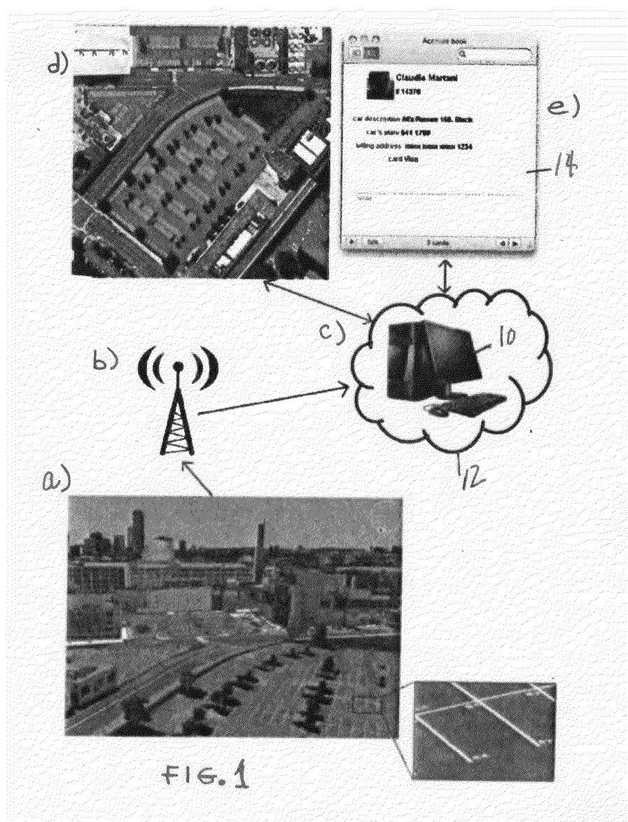

With reference first to FIG. 1(a), the system of the invention keeps a current inventory of parking availability in a city by relying on user-provided information. When a user finds an available parking place, the user reports his or her position and reservation time to the reservation system which stores and aggregates all users' parking data across the city. As shown in FIG. 1(b), information is transmitted between users and a reservation system server residing in the digital cloud¹².

The reservation system creates and updates a map of the city's parking spaces as shown in FIG. 1(d) and maintains user IDs, monitors users' geographic position and account details for online payment. FIG. 1(e) is a screenshot of a screen on a smart phone 14 programmed according to the system disclosed herein. With the user's information, the reservation system can optimally assign users to parking plots, by comparing each user's current position and trajectory against parking availability in their area. It is preferred that each parking space in the city be identified by and assigned a unique number by the parking availability database as shown in the inset in FIG. 1(a), An account hook as shown in FIG. 1(e) includes information about all of the system's registered users. For every account the information reported includes vehicle make and model, year and color, the car's license plate number, and the billing information for the account.

Communicating between users and the parking reservation system disclosed herein can be achieved either by smart phone or general mobile phone. However, is the case of an emergency (i.e., dead battery in the phone or the phone itself is out of order for any reason), users may be provided the option to use an “on-site phone” made available as a backdoor. However, the “on-site phone” solution will only allow people to pay and to extend the reservation. The parking lot identification and the self-patrolling options will be made possible only by a smart phone or a mobile cell phone.

Most smart phones today have GPS and accelerometers embedded within them as standard features. The GPS provides location and time information in all weather, anywhere on earth, with variable degrees of accuracy. Accelerometers are used to align the screen of a smart phone 14 shown in FIG. 1(e) to align the screen depending on the direction the device is held. Nearly 50% of Americans own a smart phone. All of these features make mobile phones an appropriate and convenient technological solution to identify parking plots, to pay by phone, and eventually to extend the reservation and self-patrolling.

The first step to use the Park-Pass system by smart phone is to download the application and to log in with your own account. To identify a parking plot close to a given position, a user can either type the address of the place where he/she wants to park, select it on the touchscreen map, or use the GPS (if the user's goal is to find a plot close to where he is standing right at that moment). The system at this stage will show available plots nearby the selected address. If the user is looking for a parking place in some other area of town, he can ask the system to navigate him to available plots by giving his current position with the embedded GPS. The system will compute the most convenient path and will guide the driver to the chosen site.

People can pay for their parking using an iTunes or Amazon-like procedure, namely, selecting the product and pressing the button “buy.” Since the user is logged in with their own account, the system of the invention automatically knows the billing address for charging the fee. Payment is made once a driver arrives at a site and parks the ear. The driver then inserts the plot's unique number. The user can either type in the parking spot number, scan it by using a QR system, or just use the GPS location.

At this point, on the screen on the mobile phone 14, a page will come up with the rate of that parking plot (dollar/hour) and the starting hour. The user then inserts the amount of time he wishes to purchase. The system of the invention will update in real time the parking map with the new piece of information.

If a driver, after having purchased a given duration of time, realizes that he needs extra minutes, he can update his payment by remote without any need to return to his car. He would need only to access the application with his own account and add additional time to the reservation. The payment will be charged directly to the account's billing address.

The system of the invention can also display on the mobile phone 14 screen information about objects that the phone is pointing toward. This capability is achieved by using GPS to reveal location and the accelerometers and other sensors to denote orientation in which the phone is pointing. The server 10 in the cloud 12, knowing where the user is and in which direction he is pointing his phone, can understand what he is scrolling on and then over-looping information from the phone's camera. If the system confirms that a car shouldn't be in the plot reported, then the abusive driver may be fined and the user that self-patrolled the area would receive part of the money of the fine.

The market penetration of general mobile phones (without GPS, camera, and any possibility of uploading an application) is currently more than 96%¹⁴. This means that a solution that will enable the owners of a standard mobile phone to have access to the system will guarantee that almost ail of the American population will be able to use it. With a standard mobile phone, it is possible to carry on the same operations that can be done with a smart phone: identify a parking plot, pay by phone, eventually extend the reservation, and sell-patrolling. Of course, the interaction is different than it would be with a smart phone as described above.

To identify a parking plot with a general mobile phone, a user is required to call a number at which an automatic message will require the user to login by typing an ID code. Once the account is recognized, the driver will be asked to orally give the address of the site he wants to park. The system will then compute the path and lead the driver to the place by navigating him by oral directions. With this method, the users are required to press a button every time they completed the last direction. Once a driver has arrived on site, the system will list the number of plots available nearby so that the driver can more easily find them. Since at this stage the user is already logged in, the only operation he has to do is typing the plot number occupied, the time amount, and confirm. Corresponding price will be charged on his account.

To extend the reservation, the user of a standard mobile phone only has to call a number and to login. At this point, an automatic, oral message will ask him to choose, by pressing a button, among different solutions, He may choose to extend a reservation and will add desired extra minutes that will be charged to his account.

If, when a driver arrives at a parking plot where he is supposed to find a vacant plot, he finds the space indicated from the system as vacant, busy, he will call the Park-Pass number, log in, and choose the button to select the self-patrolling option. At this point, all the driver need do is type in the plot number occupied and then the license plate of the abusive car and send a report. The abusive driver will be fined and the one who self-patrolled the area will receive part of the fine.

A solution is provided also for users that don't have any phone. An on-site phone solution is made available. With this method, drivers cannot identify a plot for self-patrolling but at least they can pay for the parking spaces and even extend their reservations. To pay with this solution, the user will take note of the plot number and ask for the Park-Pass phone.

With the present system fees are not fixed but are adaptable based on demand. That is because an adaptable price helps spread a parking space request among the city in a broader way. It is likely that most people will tend to request a parking place in the city's areas characterized by a high concentration of certain activities such as shopping. Moreover, the concentration of requests for parking plots moves from place to place and from daytime to daytime or according to temporary events.

It is preferred that the map of the city stored in the server 10 has the urban area divided into subareas and every subarea into blocks. Then, the system is able to compute, automatically at regular time intervals, the ratio between the number of requests over the total amount of plots. This computation can be done for each subarea and then for each single block and, based, on these, the server 10 would update the price of the plots. A maximum and a minimum threshold can be fixed so that the plot prices will be fluctuating within a given range.

With the present system, the size and the number of users are not fixed but adaptable from demand. Each plot, in fact, can either be a plot for a car or for five bikes/motorbikes, By shaping the plots this way, the city's parking system is no longer dedicating a certain amount of space as a bike parking space and another as a car parking space, but is able to manage the two destinations together in the same space. Ideally, in a given time, all of the plots can he dedicated to car parking or to hike parking if this is what the users are asking for at that moment.

The system for bikes works as follows. When a biker asks for a parking plot in a certain area, the system will point him. to art entire plot, as if he were a car driver. Then, when the biker arrives on the plot, he parks the bike on one of the five cells in which each plot is subdivided—named by adding a letter to the plot name—and then he can pay for the specific cell. All of the

procedures used by car drivers will be used by bike riders.

Once a plot has been occupied with a bike, the system will consider it as a “4 bike cells left plot” and it will point further bikes asking for parking space in that area to one of the four left cells before converting a new plot into five bike cells.

The superscript numbers refer to the references listed herein. The contents of all of these references are incorporated herein by reference.

It is recognized that modifications and variations of the invention disclosed herein will be apparent to those of ordinary skill in the art and it is intended that all such modifications and variations be included within the scope of the appended claims.

### REFERENCES

¹ Schrank D., Lomax T., TTI's 2011 URBAN MOBILITY REPORT Powered by INRIX Traffic Data, September 2011. Texas Transportation Institute, The Texas A&M University System.
² Remackel B., Helling A., Homer L., Nash P., Environmental Science, Policy and Management 4041 Report 5/8 Prepared for: The City of Maplewood, November 2008, University of Minnesota.
³ http://www.dksassociates.com/clksprojectsparking.asp
⁴ http://www.nyc.gov/html/dotlhtml/motoristlparksmart.shtml
⁵ Khan J. S., PARK Smart Greenwich Village Pilot Program—Results, Department of Transportation (DOT), New York City, June 2009.
⁶ http://ladot.lacity.org/pdf/PDF29.pdf
⁷ http://www.cityofchicago.org/citylenldepts/rev/suppinfo/parking_meters.html
⁸ http.//sfpark.org/
⁹ D.C. DOT spokeswoman Karyn LeBlanc, in Barnett reports for the Greenville News in South Carolina, Contributing: Rebecca Kern and Drew FitzGerald, USA TODAY. Posted Feb. 23, 2009
¹⁰ Charette. R. N., Smart Parking Systems Make It Easier to Find a Parking Space, October 2007, Ieee Sprectrum, http://spectrum.ieee.orglgreen-techladvanced-cars/smart-parking-systems-make-it-easier to-find-a-parking-space.
¹¹ http://www.rtd-denver.com/HowToPark.shtml.
¹² http://www.emarketer.comm/
¹³ CTIA, March 2011.
¹⁴ CTIA, March 2011.

What is claimed is:

1. Real-time parking availability system comprising:
a database including an inventory of parking spaces in a city including their location, size, and level of demand; and
a mobile phone programmed for access to the database to locate a vacant space, to pay for a requested time duration in the space, and to update the database to remove the space from the database of available parking spots for the requested time duration.

2. The system of claim 1 further including an augmented reality application on the mobile phone to identify whether a parked ear has paid for the space and to identify how much time remains.

3. The system of claim 1 wherein the parking spaces may accommodate an automobile or a plurality of bicycles.

4. The system of claim 1 wherein the mobile phone is further programmed to extend the requested time duration.

5. The system of claim 1 wherein the database is stored in the digital cloud.

6. The system of claim 1 wherein the cost of the requested time duration varies based on demand.
